(19) United States
(12) Patent Application Publication
(10) Pub. No.: US 2011/0116934 A1
(43) Pub. Date: May 19, 2011

(54) PUMPING ELEMENT DESIGN

(76) Inventors: Sen Y. Meng, Canoga Park, CA (US); Scott R. Sargent, Canoga Park, CA (US); Kevin J. Lunde, Canoga Park, CA (US)

(21) Appl. No.: 12/619,604

(22) Filed: Nov. 16, 2009

(51) Int. Cl. F04D 29/30; B23P 15/02; F04D 29/38

(52) U.S. Cl. 416/223 R; 29/889.7

(57) ABSTRACT

A pumping element and method of turbomachinery design includes a blade having an incidence angle (α) and a blade angle (β), wherein a ratio of α/β is less than approximately 0.3.

### BACKGROUND

The present disclosure relates to pumps, and more particularly to design methodology therefor.

Fluid pumps include axial flow pumps and centrifugal flow pumps. Pump design generally relies upon empirical relations to independently dictate the relationship between the blade angle (β) and the incidence angle (α).

### BRIEF DESCRIPTION OF THE DRAWING

Various features will become apparent to those skilled in the art from the following detailed description of the disclosed non-limiting embodiment. The drawing that accompanies the detailed description can be briefly described as follows:

FIG. 1 is a developed view of a blade leading edge.

### DETAILED DESCRIPTION

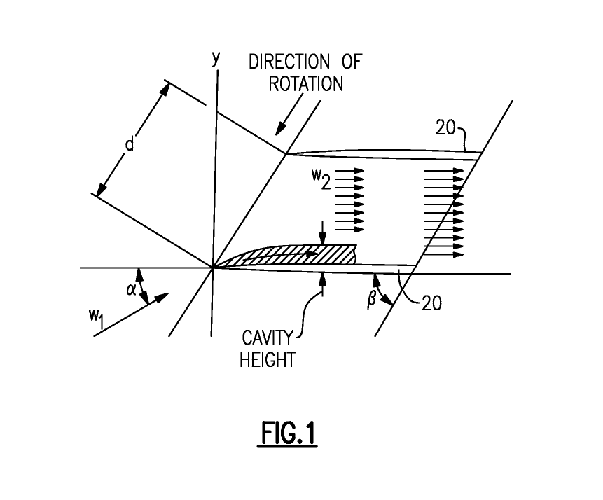

Referring to FIG. 1, there is shown a developed view of a blade 20 of a pumping element. Pumping elements include inducers and impellers.

Cavitation occurs on pump elements when the static pressure is decreased to a value below that of the fluid vapor pressure. Many types of cavitation are known to occur in fluid mechanics.

Parameters cited herein include the blade-to-blade distance (d); the blade angle defined from tangential, (β) the incidence angle referenced from the blade pressure side (α); and the velocities w₁, w₂ which represent the incoming relative velocity and the relative velocity at the location of the cavity collapse, respectively. Parameter d may be maximized to increase the blade-to-blade flow area. As applied to the pump design process disclosed herein, d is increased by a decrease in the number of blades 20.

The flow coefficient (φ) shown in Equation 1 defines the relationship between the inlet meridonal velocity (Cₘ), the blade speed (U), β, and α.

$$φ = \frac{{C}_{m}}{U} = tan ( β - α ) \qquad 1$$

The design philosophy disclosed herein may proceed first through definition of the flow coefficient (φ). The inducer flow coefficient (φ) is determined by experience for a given application. Because flow coefficient (φ) is often an independent variable in the inducer design process, the difference between the blade angle (β), and the incidence angle (α), is fixed. What can be controlled, however, is the ratio between the two. In other words, α/β may be selected. The ratio α to β is selected to be approximately 0.3 or less in the disclosed non-limiting embodiment, defined in Equation 2:

α=0.3β 2

A design philosophy of low blade number together with low α/β offers a reduction in the amplitude of cavitation induced vibrations. Increased flow area improves suction performance while a lower α/β ratio restricts or eliminates cavitation.

Substituting equation 2 into equation 1, equation 3 is obtained:

φ=tan(0.7β) 3

Because the flow coefficient, φ is known, β may be directly solved for. With β known, equation 2 is then solved for α.

The design philosophy disclosed herein constrains the value of incidence angle (α) as a function of blade angle (β) to essentially rendering the incidence angle an independent variable as opposed to the conventional process which considers incidence angle as a dependent variable.

It should be understood that like reference numerals identify corresponding or similar elements throughout the drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A pumping element comprising:
a blade having an incidence angle (α) and a blade angle (β), wherein a ratio of α/β is a number less than approximately 0.3.

2. The pumping element as recited in claim 1, wherein the ratio of α/β is a positive number less than approximately 0.3.

3. The pumping element as recited in claim 1, wherein the ratio of α/β is a negative number less than approximately 0.3.

4. A method of pumping element design comprising:
selecting an incidence angle (α) of a blade of a pumping element as a function of a blade angle (β) such that the incidence angle is an independent variable such that α is approximately equal to 0.3β.
